(19) United States
(12) Patent Application Publication
(10) Pub. No.: US 2011/0208609 A1
(43) Pub. Date: Aug. 25, 2011

(54) PERSONALIZED REMEMBRANCE SCULPTURE SYSTEM

(76) Inventors: LAURENCE DESTEPHEN, Miami Beach, FL (US); Saady Andrew Destephen, Miami Beach, FL (US); Olivier Haligon, Miami, FL (US)

(21) Appl. No.: 12/708,979

(22) Filed: Feb. 19, 2010

(51) Int. Cl. G06Q 30/00

(52) U.S. Cl. 705/26.5

(57) ABSTRACT

A method for creating a personalized sculpture comprising the using of at least one computer system, the computer system further comprising at least one template database and at least one server. The personalizing of at least one sculpture using at least one template database by allowing at least one customer to access the computer system from at least one computer terminal via the Internet. The method continues by receiving personalized sculpture orders using the computer system and sending personalized sculpture orders to a manufacturing facility using the computer system and storing information about the customers at least one database within the computer system. The system finally manufactures at least one personalized sculpture from the information stored in the at least one database.

### FIELD OF THE INVENTION

The present invention relates to the ordering and making of personalized sculptures online.

### CROSS REFERENCE TO RELATED APPLICATIONS

Not applicable.

### STATEMENT REGARDING FEDERALLY-SPONSORED RESEARCH AND DEVELOPMENT

Not applicable.

### BACKGROUND OF THE TECHNOLOGY

Since the beginning of time, humanity has had the need to memorialize objects for future generations. The Epic of Gilgamesh, among humanity's earliest literary works, begins with instructions on how to find a box of copper inside a foundation stone in the great walls of Uruk—in the box is Gilgamesh's tale, written on a lapis tablet. There were other time capsules 5,000 years ago as vaults of artifacts hidden inside the walls of Mesopotamian cities. Egyptian and other ancient tombs are effectively time capsules as well.

Current time capsules usually do not provide much useful historical information as they are typically filled with “useless junk”, in new and pristine condition. This type of time capsule tells little about the person it wants to memorialize. Many time capsules today contain only artifacts of limited value to future generations.

If time capsules have a museum-like goal of preserving the identity of a particular time, they fulfill this goal very poorly. Subsequent generations between the launch date and the target date will have no direct access to the artifacts or information; and therefore, these generations are prevented from learning from the contents directly.

Historians suggest that items that describe the daily lives of the people who created them, such as personal notes, pictures, and documents, would greatly increase the value of the time capsule. Historians also concede that there are many preservation issues surrounding the selection of the content and how to transmit this information to the future. Some of these issues include the obsolescence of technology and the deterioration of paper, electronic and magnetic storage media.

In today's modern Internet and as online commerce increases (at least 30 percent of Americans now shop the Internet) so does cyber ordering. It is possible today to order almost anything online, from pets, vehicles, houses, and infinite types of goods. On the other hand, the Internet buyer does not have the possibility of buying a personalized sculpture to memorialize content into the future. Furthermore, so far, the online merchant cannot make a profit out of personalized sculptures using a comprehensive modern system.

There is a need in the online marketplace to have a method so a person is able to order a sculpture of life for future generation. Moreover, in the memorial industry, it would be desirable to progress from the dull tombstone, barely depicting the name and age of a person, to a long lasting sculpture that tells vasts amounts of information about the person.

### BRIEF DESCRIPTION OF THE SEVERAL VIEWS OF THE DRAWINGS

The foregoing summary, as well as the following detailed description of the technology, will be better understood when read in conjunction with the appended drawings. For illustrating the technology, the figures are shown in the embodiments that are presently preferred. It should be understood, however, that the technology is not limited to the precise arrangements and instrumentalities shown. In the drawings:

FIG. 1 depicts at least one embodiment of the technology, where an internet buyer buys a personalized sculpture using the internet.

FIG. 2 depicts at least one embodiment of the technology, where in order to make the personalized sculpture, the system and structure is depicted.

FIG. 3 depicts at least one embodiment of the technology, where at least one internet website structure is depicted in order to create the system disclosed herein.

FIG. 4 depicts at least one embodiment of the technology, where it is depicted how the system works by using the telephone.

FIG. 5 depicts at least one embodiment of the technology, where it is depicted how the system works by using the mail.

FIG. 6 depicts at least one embodiment of the technology, where it is depicted the physical kit and how it is personalized by the customer.

### DESCRIPTION OF THE TECHNOLOGY

The present technology depicts an inventive solution to the fore mentioned issues related to ordering personalized remembrance sculptures online.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art. As appropriate, procedures involving the use of commercially available kits and reagents are generally carried out in accordance with manufacturer defined protocols and/or parameters, unless otherwise noted.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term or as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

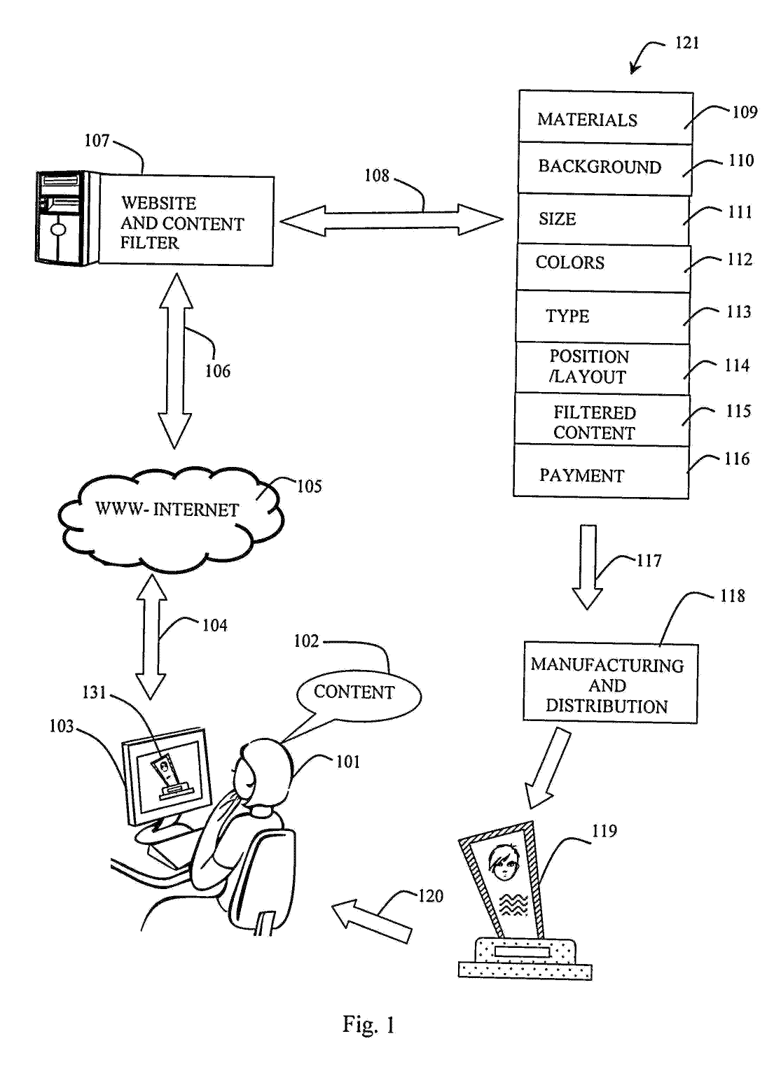

In at least one embodiment of the technology, as depicted in FIG. 1, the present technology pertains to a method to generate profits by using a website where at least one customer 101 ads its own content 102 and chooses between different shapes/layouts 114, colors 112, sizes 111, materials 109 and delivery method 120, in order to create a computer sculpture 131 online. This method continues as it is further sent to be manufactured 118 and delivered in a single streamlined computerized system. The offering of sculpture products is usually accomplished through the methods selected from the group consisting of Internet, advertising, billboards, magazines, and newspapers.

In one of the embodiments described herein is a method for creating a personalized sculpture 119 that comprises using at least one computer system, the computer system further comprising at least one server 107 and at least one template database 121. The method further comprises, personalizing at least one sculpture 119 by allowing at least one customer 101 to access said computer system 107 from at least one computer terminal 103 via the Internet. Furthermore, the method comprises uploading 106 personal content 102 to a database in the system, using a template database 121, and finally transforming said individual elements into a single personalized remembrance sculpture 119. The method further includes receiving personalized sculpture orders using a computer server 107, and sending 117 the personalized sculpture orders to a manufacturing facility 118 using said computer server 107. The system will also allow for storing information about the customers in at least one database 301 within said computer system.

Uploading 106 means either the sending of data from a local system to a remote system, such as a server 107, with the intent that the remote system should save a copy of whatever is being transferred, or the initiation of a process. Uploading 106 to the server 107 often implies that the data sent or received is to be stored permanently, or at least stored more than temporarily.

In one embodiment of the system herein, the system was composed of at least one server 107 (wherein the home e-commerce webpage was stored), and at least one database 121. Server 107, is a computer or device on a network that manages network resources. For the described technology, a file server was a computer and a storage device dedicated to storing files. Any user/customer 101 on the network 105 was able to store or upload 106 files on the server 107 which are almost simultaneously sorted and stored in the selected database 121. The servers described herein, comprised at least one computer (that manages at least one customer 101) and a network server 107 to manage the network traffic.

The servers used herein were dedicated, meaning that they perform no other tasks besides their server tasks. However, multiprocessing operating systems, or a single computer that can execute several programs at once, may be used for substantially the same purpose to obtain the same result. In addition, a server 107 in this case could refer to the program that manages resources rather than the entire computer. The platform used for the server 107 in the disclosed technology was Microsoft®. A platform is the underlying hardware or software for a system and is thus the engine that drives the server. Any other platform such as APPLE® or SYSCO®, may be used for substantially same purpose to obtain the same result.

Because there is two target markets in the business development of the technology herein, it was found advantageous to acquire at least two web-domains. Thus, the software architecture is the same, but on two different chasses. The memorial website 202B focused on having at least one e-commerce platform for customers 101 to be able to personalize and purchase a memorial personalized sculpture 202B. On the other hand, the Home-Design 202A or Commemorative e-commerce 202C platform is for customers 101 to be able to personalize and purchase specific home design and commemorative personalized sculptures.

The inventive technology and business method described herein will be able to offer the services to the public via the internet though at least one website. The specific requirements of said websites comprise at least one more language other than English, for example French or Spanish. In one embodiment of the technology, the website was created using background music to be turned off at customer discretion.

In another embodiment of the technology, the websites allowed for at least one customer to register on-line before commencing the purchase process. Furthermore, the customer was also able to choose predetermined templates and was able to manipulate content to be uploaded, such as pictures or letters using WYSIWYG technology (re-size, crop, font, size, etc.). The focus of this embodiment was that it was easy and “user friendly” to personalize the content. An example of photo editing available for the person skilled in the art is API, such as ww.picknik.com.

In yet another embodiment of the technology, the customer 101 was able to see the actual personalized sculpture in a 3-D model for their final review and approval. Lastly, the customer was able to pay online through at least one of the following online payment transfer methods, PayPal or PayPal Pro, Google Checkout, or Credit Card. The overall process can be simplified in the following steps: (1) Making a computer sculpture, (2) approving the 3D model and (3) paying Checkout.

Upon the customer 101 making the purchase online, it will trigger the following processes: (1) sending a confirmation e-mail to the customer with the Sales Order, Purchase details, estimated completion date and contacts for customer services; (2) Sending a confirmation e-mail to the office headquarters about the purchase that took place with all the details including the corresponding .PDF files with the actual personalized product; (3) sending a confirmation e-mail to the manufacturing facility so the manufacturing process can begin. The website has the ability for the office headquarters to have some basic reporting such as but not limited to, Sales Orders, Status of the Order, etc.

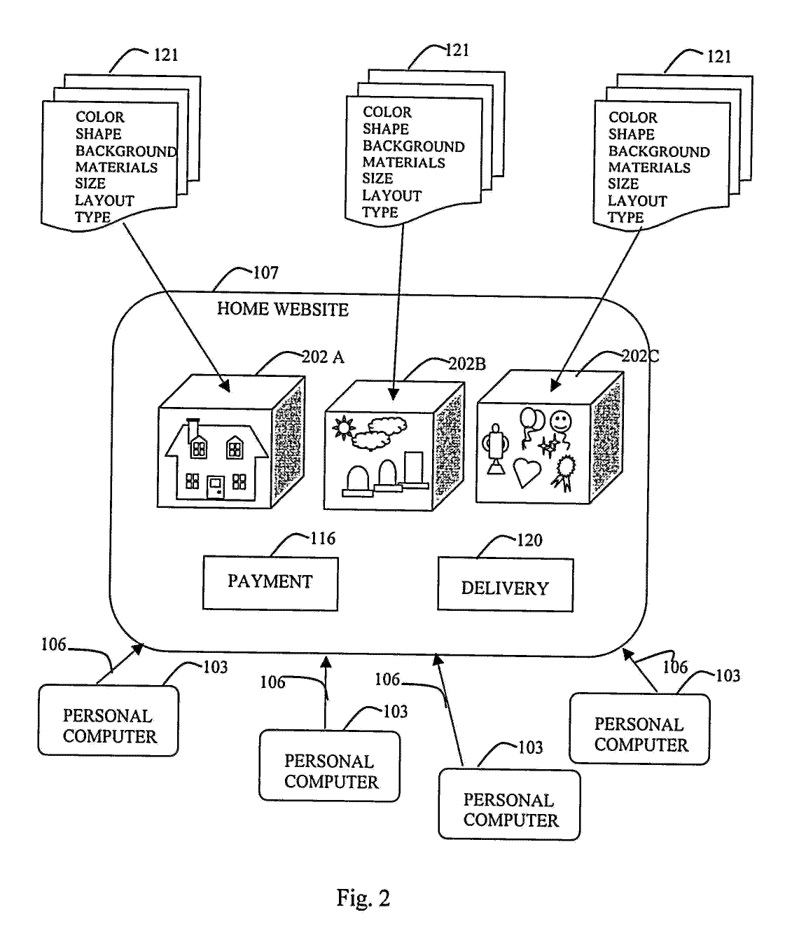

The manufacturing of the personalized sculptures 119 is from the information stored in said at least one computer system, that includes at least one server 107 and at least one database 301. This was accomplished by sending the information remotely 117 to a manufacturing facility 118, where a duplicate of the items described in the databases was physically stored. As depicted in FIG. 2, the method computer system is a web-based 105 system, which is composed of at least one computer linked together in at least one network.

In another embodiment of technology, the computer system includes a website home page, a landing page and several web pages to conduct e-business. In yet another embodiment of the technology, the receiving of payment 116 is accomplished by the means selected from the group consisting of bankcards, negotiable instruments and online payment transfer methods. Also, the template database 121 may contain the following other sub databases: a layout 114, a type/shape 113, a size 111, a color 112, a background 112, a position 114 or themes or templates.

In particularly, the template database 121 was made using a Microsoft® and a SQL (Structured Query Language) database. The Queries allow the user to describe desired data, leaving the database management system (DBMS) responsible for planning, optimizing, and performing the physical operations necessary to produce the result as it chooses. LINUX or UNIX systems may be used for substantially the same purpose to obtain the same result. The databases in the inventive system comprise systems for storing data, digital images, digital sounds, digital movies in form of different layouts 114, type/shapes 113, sizes 111, colors 112, backgrounds 110, positions 114, themes, or templates.

In another embodiment of the technology, on website 107 at least one user 101 will be able to download a Uploading and Photo Editing Software (UPES). Said UPES software is an interface software that works together with the website. Said UPES software will available on a CD or it can be downloaded directly from the website 107. When customer 101 installs the UPES software to their desktop it will automatically connect to website 107 which will initiate a registration and begin to download the following data, Albums, Templates, Colors, Themed Backgrounds, and Layouts. Once customer 101 finishes their creation, they just click a single button which will connect to website to finalize payment transaction and terms and conditions will be accepted. Finally, a file will be sent to the Manufacturing and Distribution 118 for manufacturing and customer will receive a confirmation email.

Some of the advantages of using such UPES software are that the user 101 is able to upload your personal information securely and without tying up your web browser or personal computer. Another advantage is that it will allow the user 101 to select multiple files at a time for uploading. Yet another advantage is that is allowing the user 101 to work offline at its own leisure. Said UPES software comprises a built-in full photo editor, that lets the customer 101 fix photos, as well as edit them in unique ways with frames, stickers, and special effects. Said UPES software will further comprise at least one drag and drop interfaces, have the ability to Rotate and add captions to photos before uploading. Other features include but is not restricted to, crop, resize, rotate in real-time, use fonts and type tools, a built-in organizer, to keep photos organized neatly into albums. Said UPES software works across all platforms for Windows and Macintosh operating systems.

In another embodiment of the technology as shown in FIG. 2, it depicts a method of doing business comprising: using of at least one computer system to personalize at least one sculpture 119, said system further comprising uploading 106 personal content 102 in addition to using at least one browsable catalog of sculpture templates 121, and finally transforming said individual elements into a single personalized remembrance sculpture 119. The inventive system allows for at least one customer 101 to access said computer system from at least one computer terminal 103 via the Internet as shown. The method will further comprise a means to receive said at least one personalized sculpture order using said computer system 107. Said means includes a website home page, a landing page and several web pages to conduct e-business. The same computer system would allow for sending the customized order of at least one personalized sculpture order to a manufacturing facility through the Internet or intranet. Internet is defined as a vast computer network linking smaller computer networks worldwide. Intranet is defined as a computer network with restricted access, as within a company, that uses software and protocols developed for the Internet.

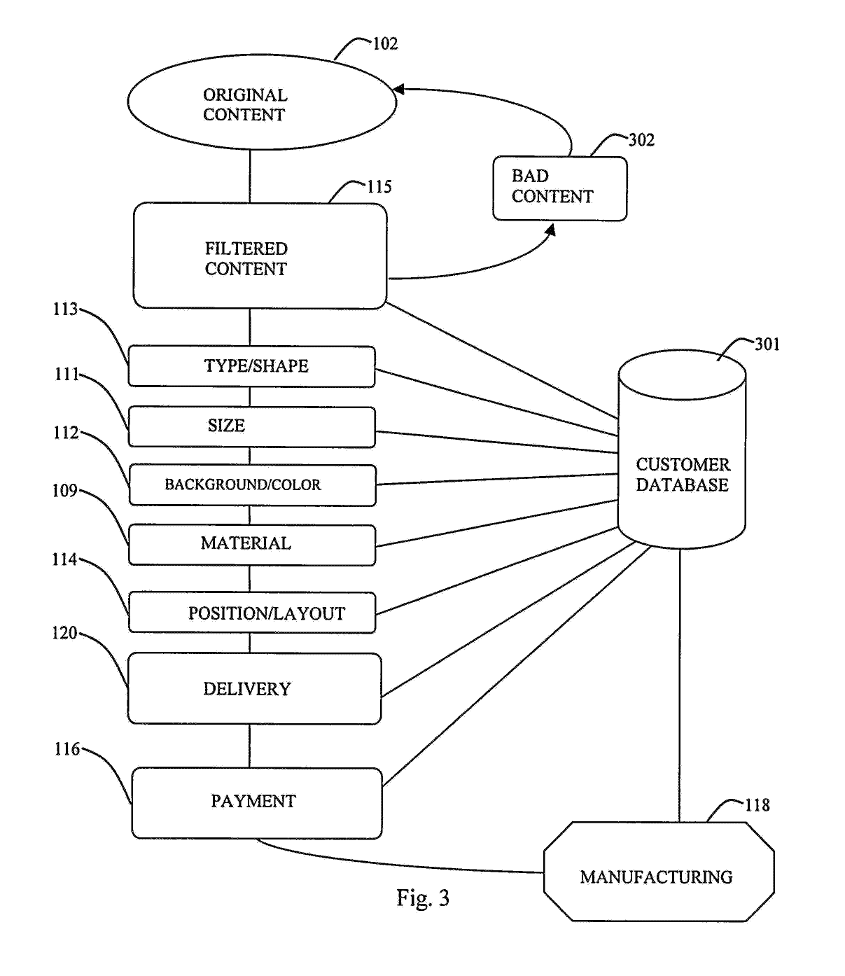

As depicted in FIG. 3, the manufacturing facility would build at least one personalized sculpture 119 from the information selected from the databases 121 or information stored therein, plus the uploaded 106 information and input from the users' 101 own content 102. Said content is filtered once it gets into the system's server 107 by special filter content that uses at least one algorithm to screen for particular words, such as racist or vulgar language. The templates already stored in the system are usually selected from the group consisting of position of layout 114, type of shape 113, size 111, color of background 112, and several premade themes. Some templates 121 are previously stored in at least a computer system or database 301. The manufacturing facility finally receives payment 116, directly from said customer by methods selected from the group consisting of: bankcards, negotiable instruments, and online payment transfer methods. Again, this computer system is a web-based system, Internet or intranet system, or a combination of both.

In yet another embodiment of the present technology, it comprises a system of selling a personalized sculpture products 119 further comprising offering sculpture products that include a browsable catalog of sculpture template databases 121 and that provides options for allowing at least one customer 101 to choose the options from said browsable catalog of sculpture template databases 121. This system also receives orders and provides the customer 101 with a business contract 405 with a set of pre-established business rules specifying legal terms for the purchasing of at least one sculpture 119. The process then continues by sending a confirmation of the order to the customer after customer accepts contract. The system makes a transaction of a sale of the product 119 with the customer 101. The inventive method finalizes by shipping 120 out product 120 to the customer 101 through normal distribution channels, and sending confirmation of shipment to the said customer 101. Normal distribution channels include air, land, and sea transportation.

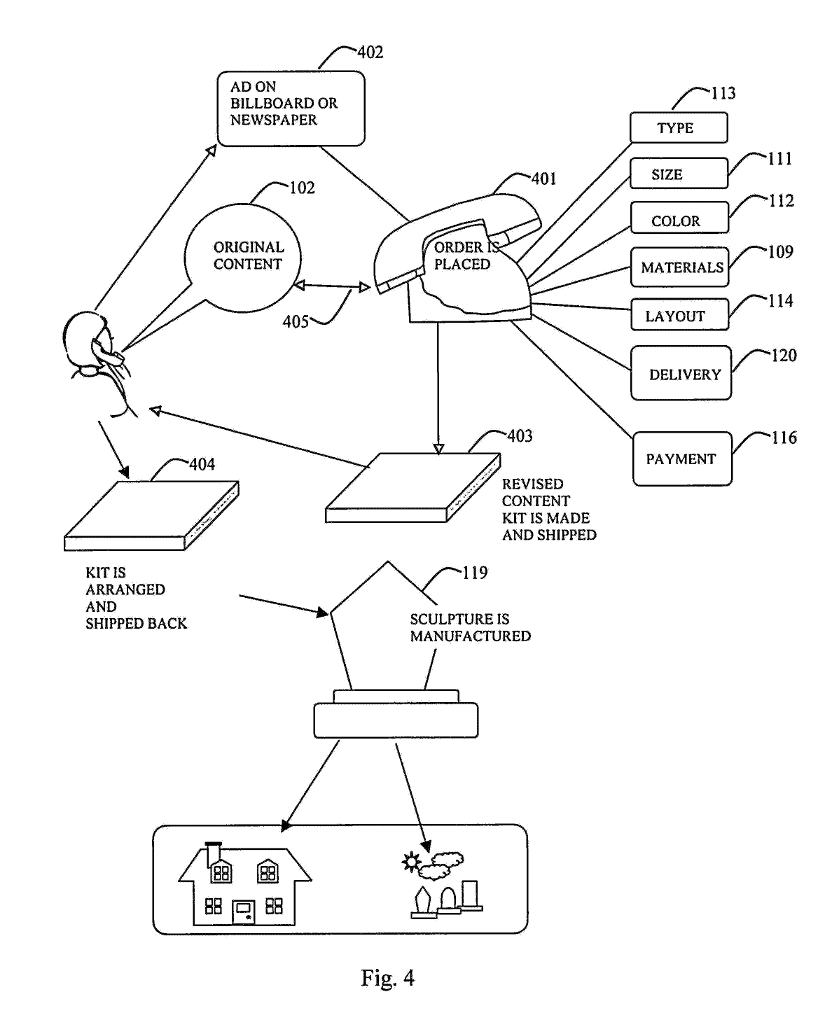

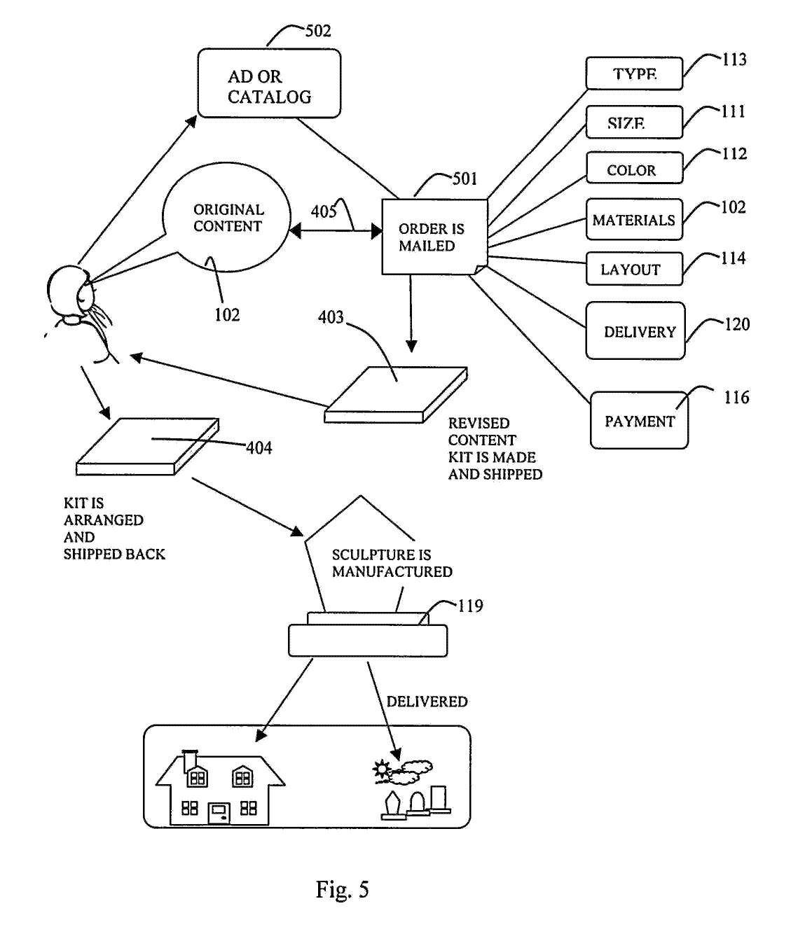

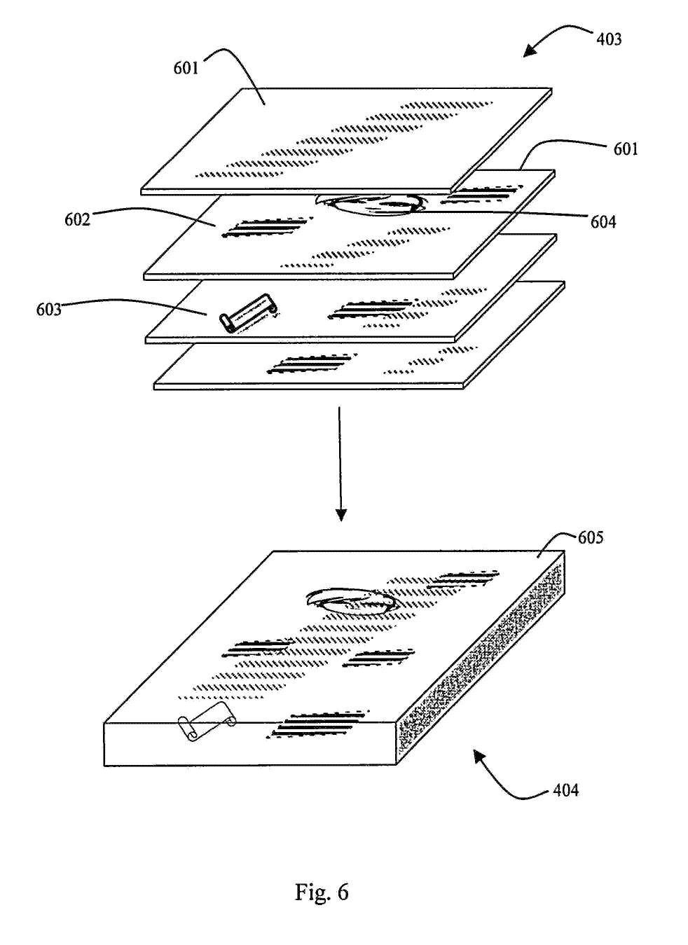

Furthermore, and in at least one alternative of the technology, as seen in FIG. 4 and FIG. 5, the inventive method provides the customer 101 with a physical kit package 403 whereby the client 101 arranges the layout of said sculpture by hand and then returns an arranged version 404 to the manufacturer for production. This inventive step allows the customer 101 to input their own desired layout by hand, with their own content, and their own colors and shapes as seen in FIG. 6. The content may include personal pictures, 604, text 602 or personal items, such as pens, medals, flowers or any other small articles, to be sandwiched between the transparent plastic layers 601, in order for it to become monolith 404.

As described in the previous paragraph, the inventive technology teaches a method for a client 101 to arrange, layout, and position a physical or computer montage of the future personalized sculpture before it is sent to manufacturing. The inventive kit is sent or given to customer service, retailers and distributor and then to every customer that has placed an order. The physical box kit 403 comprises at least one large thin box that includes, but is not limited to a manual and its instructions, a DVD, double faced detachable stickers, a prepaid postage, a full scale booklet made of at least one transparent film. The booklet is there for the customer to arrange and mount documents as seen in FIG. 6, to be placed in the personalized sculpture. Later, when the client is ready, the box kit 404 is then sent back to the studio for manufacturing. The images are scanned through the computer and then printed as the fabrication process begins.

In another embodiment of said physical kit package 403, as depicted in FIG. 4, FIG. 5, and FIG. 6, the package comprises at least one transparent layer 601, said transparent layer made of transparent polymer materials. Here, several thin polyester sheets were used, but any transparent polymer sheet, clear acrylic sheets, and even glass, or plexiglass can be used for substantially the same purpose to obtain the same result. Here the customer 101 is able to position within the layers and layout the content 102 by hand, said content 102 usually comprising pictures 604, text 602, letters, artifacts 603 or anything desired to memorialize. This content 102 is usually, but not necessarily, life memories of a deceased person. It could also be current memories for future storage and remembrances. The transparent layer 601 is later made into a monolith by melting, or gluing, and clamping the transparent layers tightly, together into a monolithic structure 605. Said montage mimics the actual physical production of the sculpture 119 later for manufacturing 118.

The computer kit packages, 202A, 202B, and 202C respectively, are to be displayed in a computer system, particularly within at least one web page with at least one link to other pages. Said computer kit packages 202A, 202B and 202C, include links to at least one database 121 where all the templates are stored, as previously described herein. The computer kit packages 202A, 202B and 202C are easily customizable by the client 101, and the client is able to upload 106 the content 102 into the websites and computerly arrange and personalize the sculpture. The client 101 arranges the layout in a computer setting and then the system further uploads an arranged version 404 to the manufacturer for production. This inventive step allows the customer 101 to input their own desired layout in the computer 103, its own content, 102 and its own colors and shapes, as seen in FIG. 2. The content may include personal pictures, text, letters, movie clips, etc.

In yet another embodiment of the present technology, the technology comprises an internet based system of selling personalized sculpture products which further comprise offering sculpture products that include a browsable catalog of sculpture templates and that provide options for allowing at least one customer 101 to choose the options from said browsable catalog of sculpture templates 121. This Internet or electronic system also receives orders and provides the customer 101 with a business contract 405 containing a set of pre-established business rules specifying legal terms for purchasing items. Furthermore, the inventive method provides the customer 101 with at least one computer kit package, 202A, 202B and 202C, respectively. The process then continues by sending a confirmation of the order to the customer after customer accepts the contract. The system makes a transaction of a sale of the product 119 from the catalog 121 with the customer 101. The inventive method finalizes by shipping 120 out the sculpture product 120 to the customer 101 through normal distribution channels and sending confirmation of shipment to the customer 101.

In yet another embodiment the present technology, a mail 501 based system of selling personalized sculpture products comprising offering sculpture products that include a browsable catalog 502 of sculpture templates and that provides options for allowing at least one customer 101 to choose the options from said browsable catalog 502 of sculpture templates 121. This mail-based system also receives mail orders and provides the customer 101 with a business contract 405 with a set of pre-established business rules specifying legal terms for purchasing items. Furthermore, the inventive method provides the customer 101 with at least one physical kit package 403. The process then continues by sending a confirmation of the order to the customer after the customer accepts the contract. The mail 501 system makes a transaction of a sale of the product 119 of the catalog 502 with the customer 101. The inventive method finalizes by shipping 120 out the sculpture product 119 to the customer 101 through normal distribution channels and sending confirmation of shipment to the customer 101.

In yet another embodiment, the present technology comprises a telephone 401 based system of selling personalized sculpture products, further comprising offering sculpture products that include a browsable catalog of sculpture templates and that provide options for allowing at least one customer 101 to choose the options from said browsable catalog 502 of sculpture templates 121. This telephone 401 based system also receives telephone 401 orders and provides the customer 101 with a business contract 405 with a set of pre-established business rules specifying legal terms for purchasing items. Furthermore, the inventive method provides the customer 101 with at least one physical kit package 403. The process then continues by sending a confirmation of the order to the customer after the customer accepts the contract. The telephone system makes a transaction of a sale of the product 119 of the catalog 502 with the customer 101. The inventive method finalizes by shipping 120 out the sculpture product 119 to the customer 101 through normal distribution channels and sending confirmation of shipment to the customer 101.

In yet another embodiment, the present technology comprises a facsimile based system of selling personalized sculpture products, further comprising offering sculpture products that include a browsable catalog of sculpture templates and that provides options for allowing at least one customer 101 to choose the options from said browsable catalog 502 of sculpture templates 121. This facsimile based system also receives fax orders and provide the customer 101 with a business contract 405 with a set of pre-established business rules specifying legal terms for purchasing items. Furthermore, the inventive method provides the customer 101 with at least one physical kit package 403. The process then continues by sending a confirmation of the order to the customer after the customer accepts the contract. The facsimile system makes a transaction of a sale of the product 119 of the catalog 502 with the customer 101. The inventive method finalizes by shipping 120 out the sculpture product 119 to the customer 101 through normal distribution channels, and sending confirmation of shipment to the customer 101.

It will be appreciated by those skilled in the art that changes could be made to the embodiments described above without departing from the broad inventive concept thereof. It is understood, therefore, that this technology is not limited to the particular embodiments disclosed, but it is intended to cover modifications within the spirit and scope of the present technology.

We claim:

1. A method for creating a personalized sculpture comprising:
using at least one computer system, said computer system further comprising at least one template database and at least one server;
personalizing at least one sculpture using said template database by allowing at least one customer to access said computer system from at least one computer terminal via the internet;
receiving personalized sculpture orders using said computer system;
sending personalized sculpture orders to a manufacturing facility using said computer system;
storing information about the customers at least one database within said computer system,
and
manufacturing at least one personalized sculpture from the information stored in said at least one computer system.

2. The method of claim 1, wherein the computer system is a web based system.

3. The method of claim 1, further comprising receiving payment by means selected form the group consisting of, bankcards, negotiable instruments and online payment transfer methods.

4. The method of claim 1, wherein said template database is selected from the group consisting of, layout, type, shape, size, color, background, position and themes.

5. The method of claim 1, wherein the customers upload personal content to said system.

6. A method of doing business comprising:
using at least one computer system to personalize at least one sculpture, said system further comprising the using of at least browsable catalog of sculpture templates;
allowing at least one customer to access said computer system from at least one computer terminal via the internet to upload personal content;
receiving said at least one personalized sculpture order using said computer system;
sending said at least one personalized sculpture order to a manufacturing facility using said computer system;
manufacturing at least one personalized sculpture from the information stored in said at least one computer system, and
receiving payment from said customer by means of said at least one computer system.

7. The method of claim 6, wherein the computer system is a web based system.

8. The method of claim 6, further comprising receiving payment by methods selected from the group consisting of, bankcards, negotiable instrument and online payment transfer methods.

9. The method of claim 6, wherein said browsable template of sculpture templates said templates selected from the group consisting of layout, type, shape, size, color, background, position and themes.

10. A system of selling a personalized sculpture product comprising:
offering sculpture products that includes a browsable catalog of sculpture templates and that provides options for allowing at least one customer to choose the options from said browsable catalog of sculpture templates and upload personal content;
receiving orders;
providing the customer with a business contract with a set of pre-established business rules specifying legal terms for purchasing items;
providing the customer with a kit package in order for them to arrange at least one layout of said sculpture;
sending confirmation of order to the customer after customer accepts contract;
transacting a sale of said product of the said catalog with the customer;
shipping out product to the customer through normal distribution channels, and
sending confirmation of shipment to the said customer.

11. The method of claim 10, wherein the system is an internet computer based system.

12. The method of claim 10, wherein receiving orders is accomplished via mail.

13. The method of claim 10, wherein receiving orders is accomplished via telephone.

14. The method of claim 10, wherein receiving orders is accomplished via facsimile.

15. The method of claim 10, wherein said transacting a sale is accomplished by means selected form the group consisting of, bankcards, negotiable instruments and online payment transfer methods.

16. The method of claim 10, wherein offering of sculpture products is accomplished through the methods selected from the group consisting of Internet, advertising, billboards, magazines and newspapers.

17. The method of claim 10, wherein said browsable catalog of sculpture templates said templates selected from the group consisting of layout, type, shape, size, color, background, position and themes.

18. The method of claim 10, wherein said kit is a compilation of arrangeable layers mimicking said sculpture products.

19. The method of claim 10, wherein said kit further comprises a manual and its instructions, a DVD, double faced detachable stickers, a prepaid postage and a full scale booklet made of at least one transparent film.

20. The method of claim 10, wherein said method is used to preserve life memories of at least one deceased person.
